(19) United States
(12) Patent Application Publication
(10) Pub. No.: US 2014/0159357 A1
(43) Pub. Date: Jun. 12, 2014

(54) MOLDING APPARATUS AND METHOD FOR MANUFACTURING CRASH PAD

(71) Applicants: Kia Motors Corporation, Seoul (KR); Hyundai Motor Company, Seoul (KR)

(72) Inventor: Byung Seok Kong, Gunpo (KR)

(21) Appl. No.: 13/914,999

(22) Filed: Jun. 11, 2013

(30) Foreign Application Priority Data
Dec. 12, 2012 (KR) 10-2012-0144399

(51) Int. Cl. B60R 21/04; B29C 45/14

(52) U.S. Cl. CPC B60R 21/04; B29C 45/14508
USPC 280/751; 425/515; 264/46.5

(57) ABSTRACT

A molding apparatus and method for manufacturing a crash pad of a vehicle. The molding apparatus includes a foam skin forming upper mold, a lower mold, and a slide mold. A bubble solution is injected into the lower mold and combined with the foam skin forming upper mold. The slide mold is configured to be slidable toward the lower mold at an end portion of the foam skin forming upper mold. In addition, the slide mold includes a protrusion part that protrudes towards the lower mold.

### CROSS-REFERENCE TO RELATED APPLICATION

This application claims under 35 U.S.C. §119(a) the benefit of Korean Patent Application No. 10-2012-0144399 filed Dec. 12, 2012, the entire contents of which are incorporated herein by reference.

### BACKGROUND

(a) Technical Field

The present invention relates to a molding apparatus and method for manufacturing a crash pad of a vehicle. More particularly, the present invention relates to a molding apparatus and method for manufacturing a crash pad of a vehicle, which prevents a leakage of bubble solution upon forming of a foaming layer and increases the compressed depth upon pushing of the surface.

(b) Background Art

Generally, crash pads are used as an interior material that is installed at front of the driver and passenger seats to protect passengers during a collision. These crush pads are formed of foamed materials to achieve elastic cushion performance and impact absorbing characteristics to a certain degree while providing an aesthetically enhanced surface condition.

Crash pads for a vehicle usually include a skin that is a surface material providing aesthetic enhanced surface condition and a core that serves as a framework of the crash pad within the skin. A foaming layer such as polypropylene (PP) foam and/or polyurethane (PU) foam is interposed between the skin and the core to provide cushioning performance and impact-absorbing performance

FIG. 1 is an exemplary view illustrating a process of manufacturing a typical crash pad, which shows a process of manufacturing a crash pad having a foaming layer by injecting a bubble solution into a cavity between the core and the skin that are formed simultaneously.

As shown in FIG. 1, a core 1 is formed by injecting molten resin into a core forming cavity between a core forming upper mold 11 and a lower mold 12 that are combined, and simultaneously, a skin 2 is vacuum-formed in a foam skin forming upper mold 13. Next, the core forming upper mold 11 is separated from the lower mold 12, and the foam skin forming upper mold 13 attached with the skin 2, which is vacuum-formed, is combined with the lower mold 12 in which the core 1 is formed. Thereafter, a forming layer 3 is formed by injecting a bubble solution into a foaming cavity between the core 1 of the lower mold 12 and the skin 12 of the foam skin forming upper mold 13.

FIG. 2 is an exemplary detailed view of a portion of a crash pad manufactured by a typical manufacturing method of FIG. 1, which shows a closed foaming method using a sealing protrusion 1a of a core 1.

As shown in FIG. 2, a foaming layer is formed by a closed foaming method without a leakage of bubble solution upon forming of a foaming layer 3, by forming a sealing protrusion 1a on one side of the core 1 upon forming of the core, reciprocating a slide mold 14 before the bubble solution is injected into the foaming cavity between the core 1 and the skin 2, and overlapping the sealing protrusion 1a of the core 1 with the skin 2 to seal the core 1 and the skin 2.

When a crash pad is manufactured by this typical method, the sealing protrusion 1a of core 1 and the skin 2 overlap to be sealed. However, sealing by the sealing protrusion may fail due to the dimensional tolerance and instability caused by the mold tolerance and material shrinkage, and as indicated by the dotted line of FIG. 2, a leakage of the bubble solution may occur due to a certain gap between the sealing protrusion 1a of core 1 and the skin 2.

When a leakage of bubble solution occurs as described above, the reliability of the foaming pressure and foaming amount of bubble solution may be reduced, and the adhesion between a product and a mold may cause difficult in injecting the bubble solution. Also, when the crash pad is manufactured using the typical method described above, the density of the foaming layer and the thickness of the skin are increased to enable the foaming throughout the entire section up to both ends with a substantially thin thickness. In such case, due to the density of the foaming layer and thickness of the skin, the surface hardness of the crash pad may reduce customer satisfaction.

More specifically, when a crash pad is manufactured by a typical method, for a user to feel the softness of the crash pad when the surface is pushed, the crash pad must show a minimum compression response of about 3 mm with respect to a minimum force of about 15N applied when the surface of crash pad is pushed by a finger. However, a typical crash pad may not meet these requirements, and has a surface hardness difficult to feel softness unless the surface is strongly pushed.

The above information disclosed in this Background section is only for enhancement of understanding of the background of the invention and therefore it may contain information that does not form the prior art that is already known in this country to a person of ordinary skill in the art.

### SUMMARY

The present invention provides a molding apparatus and method for manufacturing a crash pad of a vehicle, which prevents a leakage of bubble solution by preventing occurrence of a dimensional tolerance due to a material shrinkage to minimize a tolerance of a sealing part and improves the surface feel of the crash pad by applying a foam skin including a skin foam layer instead of a typical skin to increase the compressed depth upon pushing of the surface of the crash pad.

In one aspect, the present invention provides a molding apparatus for manufacturing a crash pad of a vehicle, including: a foam skin forming upper mold; a lower mold formed into which a bubble solution is injected and combined with the foam skin forming upper mold; and a slide mold configured to be slidable to the lower mold at an end portion of the foam skin forming upper mold, wherein the slide mold has a protrusion part protruding to the lower mold.

In an exemplary embodiment, the slide mold may include a pair of slide molds configured at both end portions of the foam skin forming upper mold. In addition, the foam skin forming upper mold may be a vacuum forming mold that forms a foam skin by vacuum forming.

In still another exemplary embodiment, the molding apparatus may include a core forming upper mold that forms a cavity by combining with the lower mold and is configured to form a core by injecting a molten resin into the cavity. In addition, the protrusion part of the slide mold may be formed to face the lower mold toward an end of a core seated on the lower mold.

In still yet another exemplary embodiment, the molding apparatus may include a mold transfer device that moves the core forming upper mold and the foam skin forming upper mold to alternately combine the core forming upper mold and the foam skin forming upper mold with the lower mold.

In another aspect, the present invention provides a molding method for manufacturing a crash pad of a vehicle, including: vacuum-forming, by a foam skin forming upper mold, a foam skin including a skin and a skin foam layer under the skin and simultaneously forming, by a slide mold of the foam skin forming upper mold, a foam skin protrusion part at an end portion of the foam skin; combining the foam skin forming upper mold to which the foam skin is attached with a lower mold in which a core is formed; pressuring, by a protrusion part of the slide mold, the foam skin protrusion part toward the core to allow the foam skin protrusion part to adhere closely to the end of the core by pushing an end portion of the foam skin toward the core when the slide mold of the foam skin forming upper mold operates; and forming a foaming layer by injecting a bubble solution into a foaming cavity between the core of a core forming upper mold and the foam skin of the foam skin forming upper mold, wherein the method prevents a leakage upon forming of the foaming layer by sealing the core and the foam skin.

In an exemplary embodiment, the foam skin protrusion part may include a pair of foam skin protrusions configured to be pressurized and adhered closely to both ends of the core. In addition, the skin may be formed of a thermoplastic polyolefin material, and the skin foam layer may be formed of a polypropylene foam or a thermoplastic polyolefin foam. The skin may be formed to have a thickness of about 0.3 mm to about 1.0 mm, and the skin foam layer may be formed to have a thickness of about 1.0 mm to about 3.0 mm. The polypropylene foam or the thermoplastic polyolefin foam used for the skin foam may be formed by foaming a polypropylene or thermoplastic polyolefin material at a magnitude of about 10× to about 25×.

In another aspect, the present invention provides an injection product for a crash pad of a vehicle, including: a core that is injection-molded; a foam skin including a skin and a skin foam layer stacked within the skin; and a foaming layer formed by injecting a bubble solution into a cavity between the core and the foam skin, wherein the foam skin includes a foam skin protrusion part protruding toward the core, and the foam skin protrusion part is pressurized and adhered closely to an end of the core.

In an exemplary embodiment, the foam skin protrusion part may include a pair of foam skin protrusions configured to be pressurized and adhered closely to both ends of the core. In addition, the skin may be formed of a thermoplastic polyolefin material, and the skin foam layer may be formed of a polypropylene foam or a thermoplastic polyolefin foam. The skin may be formed to have a thickness of about 0.3 mm to about 1.0 mm, and the skin foam layer may be formed to have a thickness of about 1.0 mm to about 3.0 mm. The polypropylene foam or the thermoplastic polyolefin foam used for the skin foam may be formed by foaming a polypropylene or thermoplastic polyolefin material at a magnitude of about 10× to about 25×.

### BRIEF DESCRIPTION OF THE DRAWINGS

The above and other features of the present invention will now be described in detail with reference to exemplary embodiments thereof illustrated the accompanying drawings which are given hereinbelow by way of illustration only, and thus are not limitative of the present invention, and wherein:

FIG. 1 is an exemplary view illustrating a process of manufacturing a typical injection product for a crash pad according to the related art;

FIG. 2 is an exemplary detailed view illustrating a portion of an injection product for a crash pad manufactured by a typical manufacturing method in FIG. 1 according to the related art;

FIG. 3 is an exemplary view illustrating a process of manufacturing an injection product for a crash pad according to an exemplary embodiment of the present invention;

FIG. 4A is an exemplary detailed view of FIG. 3 according to an exemplary embodiment of the present invention;

FIG. 4b is an exemplary view illustrating a central structure of an injection product for a crash pad manufactured in FIG. 3 according to an exemplary embodiment of the present invention; and

FIG. 5 is an exemplary graph illustrating a compressed depth upon pushing of the surface of an injection product for a crash pad according to an exemplary embodiment of the present invention.

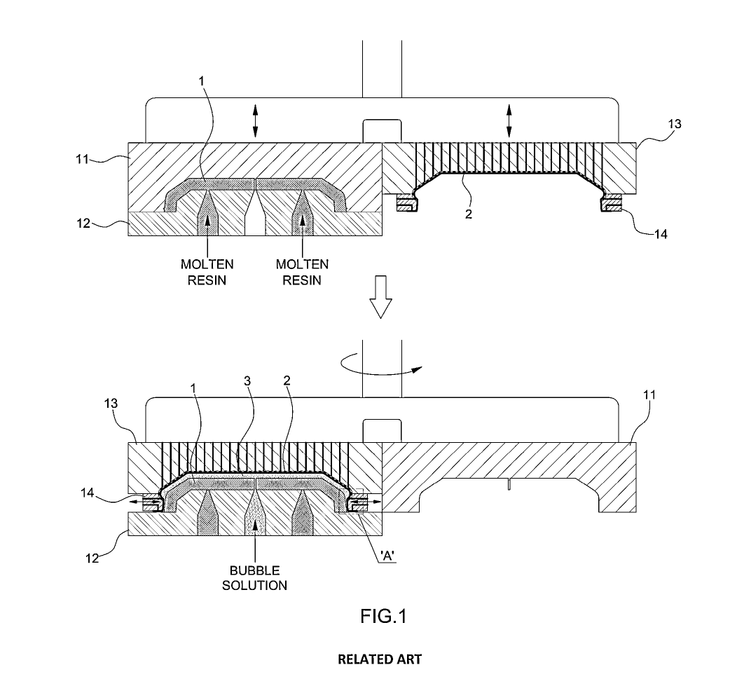

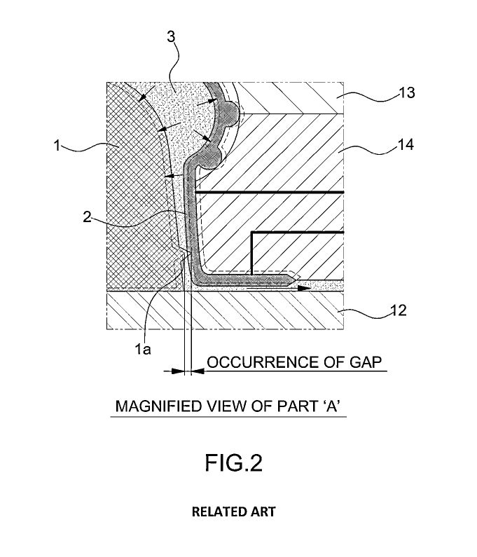

Reference numerals set forth in the Drawings includes reference to the following elements as further discussed below:

| | |
|---|---|
| 10: core | 20: foam skin |
| 21: skin | 22: skin foam layer |
| 23: foam skin protrusion part | 30: foaming layer |
| 110: core forming upper mold | 111: pin part |
| 120: lower mold | 121: molten resin injection |
| | passageway |
| 122: bubble solution injection | 130: foam skin forming upper mold |
| passageway | |
| 140: slide mold | 141: protrusion part of slide mold |

It should be understood that the accompanying drawings are not necessarily to scale, presenting a somewhat simplified representation of various exemplary features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter reference will now be made in detail to various exemplary embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Hereinafter, exemplary embodiments of the present invention will be described in detail with reference to the accompanying drawings so that those skilled in the art can easily carry out the present invention.

The present invention relates to an apparatus and method for manufacturing a crash pad of a vehicle, which may improve the consumer satisfaction by removing a typical dimensional tolerance due to a material shrinkage to prevent a leakage of bubble solution injected between a skin and a core and applying a foam skin on the surface to prevent the reduction of the surface feel upon pushing of the surface of the crash pad due to the density of a foaming layer and thickness of the skin.

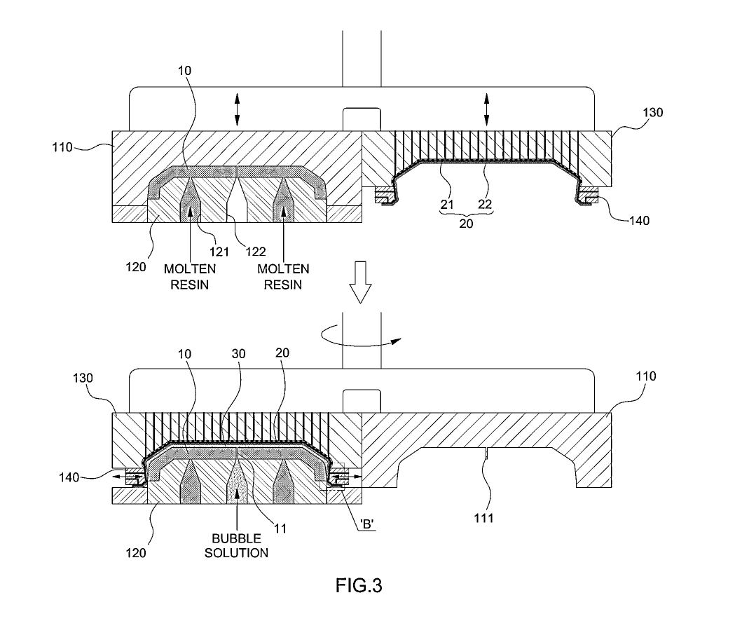

FIG. 3 is an exemplary view illustrating a process of manufacturing an injection product for a crash pad including a foam skin and a core. An injection mold for molding the core is shown on the left top of FIG. 3, and an upper mold for molding the foam skin is shown on the right top of FIG. 3.

FIG. 3 illustrates an exemplary process of forming a foaming layer 30 between a core 10 and a foam skin 20. In this process, the core 10 may be injection-molded using an upper mold 110 and a lower mold 120 that are combined with each other to form the core, and simultaneously, the foam skin 20 may be vacuum-formed using the foam skin forming upper mold 130. Thereafter, the foam skin forming upper mold 130 may be combined with the core forming upper mold 110 to form the foaming layer 30 between the core 10 and the foam skin 20.

As shown in FIG. 3, to form the core 10, a molten resin may be injected into a cavity to form the core between the upper mold 110 and the lower mold 120 that are combined with each other to form the core. Simultaneously, the foam skin 20 may be vacuum-formed in the foam skin forming upper mold 130.

The foam skin 20 may include a skin 21 that is the surface of the crash pad and a skin foam layer 22 that is stacked inside the skin 21. While the core 10 is injection-molded, the foam skin 20 may be formed in the foam skin forming upper mold 130. First, a skin material may be inserted into and preheated in the foam skin forming upper mold 130, and then vacuum adsorption may be performed for the vacuum formation of the skin 21. Next, a skin foam layer material may be inserted into and preheated in the foam skin forming upper mold 130, and may be adhered closely to the lower part of the skin 21 for the vacuum formation of the skin foam layer 22.

For example, the foam skin forming upper mold 130 may be a female type of vacuum forming mold for forming the foam skin 20 by the vacuum forming. The foam skin forming upper mold 130 may be used as a foaming layer forming upper mold that forms the upper part of the foaming cavity for forming the foaming layer 30. Here, the skin foam layer 22 may be formed of a polypropylene (PP) foam or a thermoplastic polyolefin (TPO) foam, and the skin 21 may be formed of a TPO material.

After the simultaneous forming of the core 10 and the foam skin 20, the core forming upper mold 110 may be lifted and rotated to be separated from the lower mold 120, and the foam skin forming upper mold 130, to which the foam skin 20 vacuum-formed is adhered, may be combined with the lower mold 120 in which the core is molded. Specifically, a mold transfer device (not shown) may be used to move the mold to allow the two molds 110 and 130 to be sequentially combined with the lower mold 120 for the foaming and the simultaneous forming of the core 10 and the foam skin, i.e., to allow the core forming upper mold 110 and the foam skin forming upper mold 130 to be alternately used for the lower mold 120.

The mold transfer device may be controlled by a controller (not shown) when the core forming upper mold 110 and the foam skin forming upper mold 130 are mounted therein. The two upper molds 110 and 130 may be alternately moved toward the upper side of the lower mold 120, and similarly to a typical mold closing, the corresponding mold may be selectively taken down to be combined with the lower mold 120.

For example, the mold transfer device may include a rotational mold transfer device that may vertically move the molds 110 and 130 along the rotating track. The rotational mold transfer device may alternately move the two molds 110 and 130 according to the corresponding process to allow the lower mold 120 to be closed together with the two molds 110 and 130. That is, in the core injection process, the core forming upper mold 110 may be moved toward the upper side of the lower mold 120, and may be taken down to allow the lower mold 120 to be closed together with the two molds 110 and 130. When each process is completed, the upper molds used in each process may be lifted and separated from the lower mold 120, and then may be moved. Since the rotational mold transfer device is known to those skilled in the art, a detailed description thereof will be omitted herein.

Thus, the lower mold for injection-molding the core 10 and the lower mold for foaming the foaming layer 30 may be used as the lower mold 120. The upper mold for forming the foaming layer 30 and the foam skin forming upper mold 130 for forming the foam skin 20 may be used as one mold. In particular, the core forming upper mold 110 that is an upper mold for injection-molding the core may be used only for the injection of the core.

In addition, after the forming of the core 10 and the foam skin 20, a spatial portion between the foam skin 20 and the core 10, (e.g., a cavity formed by the coupling of the foam skin forming upper mold 130 adhered with the foam skin 20 and the lower mold 120 adhered with the core 10) may become a foaming cavity into which a bubble solution may be injected. In particular, the lower mold 120 may include a molten resin injection passageway 121 to form the core, and a bubble solution injection passageway 122 through which bubble solution may be injected into the foaming cavity therebetween in a closed (combined) state where the lower mold 120 is combined with the foam skin forming upper mold 130.

A bubble solution may be injected from lower side of the core 10 through the bubble solution injection passageway 122 into the lower mold 120. In this case, since the injected bubble solution may pass through the core 10 to be injected into the foaming cavity thereon, the core 10 formed by the lower mold 120 and the core forming upper mold 110 may include an aperture through which the bubble solution flows in the upward direction.

Accordingly, to form the aperture 11 through which the bubble solution flows in the core, a pin part 111 may downwardly protrude from the inner surface of the core forming upper mold 110 at a location (corresponding to the bubble solution injection passageway in a closed state of mold) corresponding to the bubble solution injection passageway 122 of the lower mold 120.

Moreover, when the core forming upper mold 110 and the lower mold 120 are combined into a closed state (combined state), the pin part 111 of the core forming upper mold 110 may face the bubble solution injection passageway 122 of the lower mold 120 at the core forming cavity (cavity of mold) formed in both molds. In particular, when molten resin is injected through the injection passageway 121, the core 10 having the aperture 11 formed by the pin part 111 may be formed.

Although the pin part 111 of the core forming upper mold 110 is shown as one in the embodiment of FIG. 3, a plurality of pin parts may be used. In particular, a plurality of apertures may be formed in the core. In this case, the bubble solution injection passageway may be disposed in the lower mold corresponding to the number of the pin parts and the apertures of the core to allow the bubble solution to be simultaneously injected through each through aperture.

The core forming upper mold 110 may include the pin part therein, and may include a cavity structure that forms the upper part of the core forming cavity therein. In this embodiment, the basic configuration of the foam skin forming upper mold 130 may be similar to that of a typical vacuum forming mold in that vacuum apertures are formed to vacuum-adsorb the forming material and the forming material is preheated and adsorbed.

The foam skin forming upper mold 130 adhered with the foam skin 20, combined with the core forming upper mold 110 formed with the core 10, is shown on the left bottom of FIG. 3. When the foam skin forming upper mold 130 is combined with the lower mold 120, both end portions of the foam skin 20 may be pushed toward the core 10 seated in the lower mold 120 by the sliding operation of a slide mold 140. In particular, the skin foam layer 22 may be pressurized by the slide mold 140, wherein the materials may not affected by the material shrinkage, and thus may be adhered closely to both ends of the core 10 to seal the core 10 and the foam skin 20.

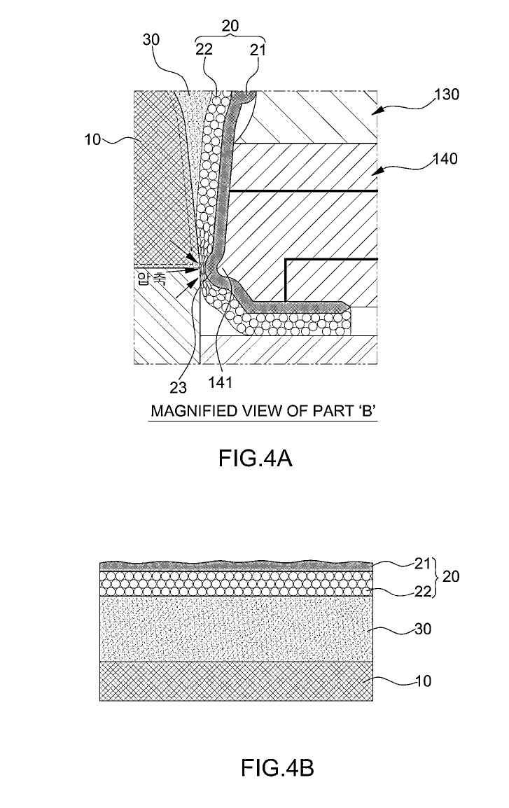

FIG. 4A is an exemplary detailed view of FIG. 3. In FIG. 4A, the skin foam layer 22 may be compressed by a foam skin protrusion part 23 pressurized toward the lower mold 120 adjacent to the end of the core 10 by the slide mold 140. As shown in FIGS. 3 and 4A, the foam skin forming upper mold 130 may include the slide mold 140 that pushes and pressurizes both end portions of the foam skin 20 at the right and left lower sides thereof toward the core 10. The slide mold 140 may include a protrusion part 141 that adheres the foam skin protrusion part 23 closely to the end of the core 10. After the foam skin forming upper mold 130 and the core forming upper mold 110 are combined with each other, the sliding operation of the slide mold 140 may adhere the foam skin protrusion part 23 closely to the right and left ends of the core 10, compressing the skin foam layer 22 of the foam skin 20.

Since the protrusion part 141 may protrude to face the end of the core 10 formed and seated in the lower mold 120, when both end portions of the foam skin 20 are pushed toward the core by the sliding of the slide mold 140, the foam skin protrusion part 23 may be pushed toward the end of the core. Thus, as the skin foam layer 22 is compressed and adhered closely to both ends of the core 10, the core 10 and the foam skin 20 may be sealed. In other words, the protrusion part 141 of the slide mold 140 may be moved toward the lower mold 120 adjacently to the end of the core 10 when pressurized toward the core 10 by the operation of the slide mold 140. Thus, the foam skin 20, particularly, the foam skin protrusion part 23 may be pressurized toward the end of the core 10 and the lower mold 120 adjacent thereto, thereby sealing the core 10 and the foam skin 20.

That is, the foam skin protrusion part 23 may be pressurized toward the end of the core 10 and the lower mold 120 adjacent thereto and may be adhered closely to the end of the core 10 while supported by the protrusion part 141 upon sliding of the slide mold 140. In addition, the skin foam layer 22 may be pressurized and compressed toward the core 10 by the protrusion part 141 of the slide mold 140, wherein the skin foam layer 22 may not affected by the material shrinkage, sealing the foam skin 20 and the core 10 and thus preventing a leakage of the bubble solution upon foaming of the foaming layer 30.

Accordingly, the skin foam layer 22 of the foam skin 20 may be used as a compression subject to form a seal between the core 10 and the foam skin 20. In addition, the increase effects of sealing efficiency and tolerance absorption rate may be achieved through the increase (about 10 to 25 times) of the compression rate compared to a typical material due to the characteristics of the foaming material For example, the skin foam layer 22 may be formed of a polypropylene (PP) foam or a thermoplastic polyolefin (TPO) foam that is foamed at about 10× to about 25× foaming magnitude of PP or TPO material to obtain the above effect.

The foam skin protrusion part 23 may be formed at both end portions of the foam skin 20 by the protrusion part 141 of the slide mold 140 disposed at both lower ends of the foam skin forming upper mold 130 when the foam skin 20 is formed by the foam skin forming upper mold 130. More specifically, since the slide mold 140 has vacuum apertures for vacuum-adsorbing the molding material similarly to the foam skin forming upper mold 130, the slide mold 140 may form both end portions of the foam skin 20 when the foam skin forming upper mold 130 forms the foam skin 20. In particular, the protrusion part 23 may be formed on both end portions of the foam skin 20 through the protrusion part 141 of the slide mold 140.

The slide mold 140 may be slidably coupled to both lower ends of the foam skin forming upper mold 130, and may move when the foam skin forming upper mold 130 moves to combine with the lower mold 120 after the forming of the foam skin 20. In addition, when the foam skin forming upper mold 130 is combined with the lower mold 120, the slide mold 140 may allow the core 10 and the foam skin 20 to adhere closely to each other at the both end portions thereof through sliding toward the lower mold 120.

Although FIG. 3, which is a cross-sectional structure, shows only two slide molds 140 at the right and left sides thereof, a plurality of slide molds 140 may be disposed along the edge of the foaming cavity at both end portions of the core forming upper mold 110 to perform sliding.

When the core 10 and the foam skin 20 are sealed, a bubble solution may be injected into the foaming cavity between the core 10 of the core forming upper mold 110 and the foam skin 20 of the foam skin forming upper mold 130 to form the foaming layer 30.

FIG. 4A illustrates the skin foam layer 22 compressed when the protrusion part 141 of the slide mold 140 adheres closely to one end of the core 10. FIG. 4b illustrates a central sectional structure of an injection product for a crash pad manufactured according to an exemplary embodiment of the present invention. As shown in FIGS. 4A and 4B, the injection product for the crash pad may include a core 10 injection-molded, a foam skin 20 vacuum-formed, and a foaming layer 30 that is formed by injecting a bubble solution into a foaming cavity between the core 10 and the foam skin 20. Particularly, since the sealing between the core 10 and the foam skin 20 is performed by adhering the foam skin protrusion part 23 protruding to the core 10 closely to the end of the core 10, a leakage of the bubble solution may be prevented when the foaming layer 30 is formed.

In this embodiment, since the sealing between the core 10 and the foam skin 20 may be disposed at both ends of the core 10, and the foam skin protrusion part 23 may be pressurized by the protrusion part 141 of the slide mold 140 to allow the foam skin protrusion part 23 to adhere closely to the end the core 10. Thus, since the tolerance by a typical material shrinkage may be removed, the accumulative tolerance of the sealing location may be reduced, and thus a leakage of the bubble solution may be prevented between the core 10 and the foam skin 20. In addition, since the foam skin 20 including the skin foam layer 22 formed of PP foam or TPO foam may be applied to the surface of the crash pad to increase the sealing efficiency, the leakage of the bubble solution may be prevented.

Additionally, as shown in FIG. 4B, the foam skin 20 may include the skin 21 and the skin foam layer 22 stacked thereunder. In this embodiment, the skin 21 may be formed of a TPO material having a thickness of about 0.3 mm to about 1.0 mm, preferably, about 0.6 mm. The skin foam layer 22 may be formed of PP foam or TPO foam having a thickness of about 1.0 mm to about 3.0 mm, preferably, about 2.5 mm. Furthermore, the core 10 may be formed of a polypropylene (PP) material having a thickness of about 2.5 mm to about 3.0 mm, and the foaming layer 30 may be formed of polyurethane (PU) foam that is foamed at about 7× to about 10× magnitude of a polyurethane (PU) material.

The foam skin 20 formed to have the above-mentioned thickness and material may be improved in softness due to the reduction of the skin and the improvement of the surface feel of the skin foam layer 22 compared to a related art.

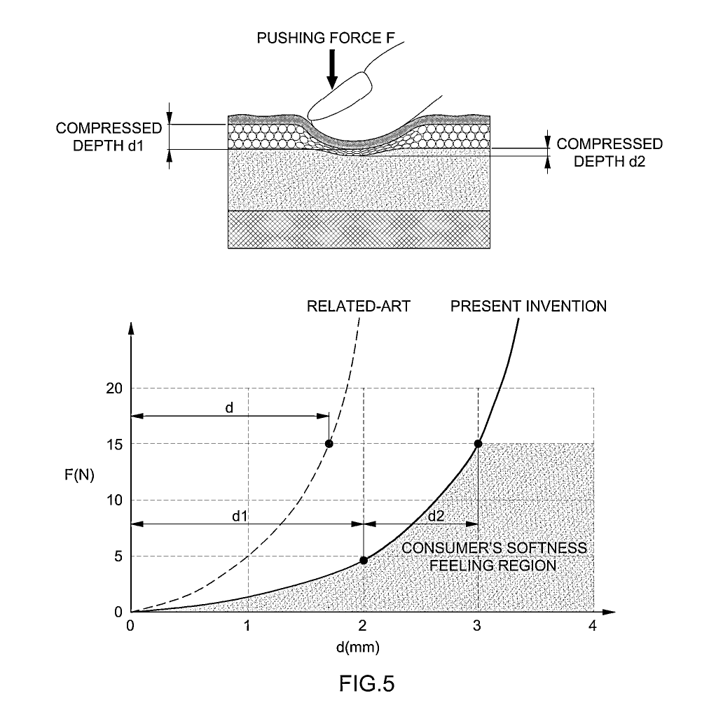

FIG. 5 is an exemplary graph illustrating a compressed depth upon pushing of the surface of an injection product for a crash pad according to an exemplary embodiment of the present invention, which is compared with a typical crash pad with a skin formed of a TPO material having a thickness of about 1.3 mm. As shown in FIG. 5, a crash pad may include a foam skin in which a skin formed of a TPO material and a skin foam layer formed of a PP foam or a TPO foam that may be foamed at an about 10× to about 25× magnitude may be stacked on a foaming layer formed of a PU foam that may be foamed at an about 7× to about 10× magnitude. Thus, the compressed depth by a pushing force of a crash pad may be improved compared to a related art, showing a compressed depth of about 3 mm with respect to a minimum pushing force 15 N by a finger on the surface of the crash pad and thus allowing a consumer to feel softness upon pushing of the crash pad. This softness improvement may result from the reduction of the skin compared to a related art and application of the skin foam layer having a compression rate about two times higher than that of the foaming layer, and the surface feel and satisfaction of consumers may be improved through the improvement of the compression depth of the crash pad.

According to an embodiment of the present invention, a leakage of the bubble solution may be prevented by removing a typical dimensional tolerance due to a material shrinkage to minimize a tolerance of a sealing part and applying a foam skin instead of a typical skin to improve the sealing efficiency. In addition, the surface feel may be improved by increasing the compressed depth upon pushing of the surface using the foam skin including a skin foam layer and a skin.

The invention has been described in detail with reference to exemplary embodiments thereof. However, it will be appreciated by those skilled in the art that changes may be made in these embodiments without departing from the principles and spirit of the invention, the scope of which is defined in the accompanying claims and their equivalents.

What is claimed is:

1. A molding apparatus for manufacturing a crash pad of a vehicle, comprising:
a foam skin forming upper mold;
a lower mold formed into which a bubble solution is injected and combined with the foam skin forming upper mold; and
a slide mold configured to be slidable toward the lower mold at an end portion of the foam skin forming upper mold, wherein the slide mold includes a protrusion part protruding toward the lower mold.

2. The molding apparatus of claim 1, wherein the slide mold includes a plurality of slide molds disposed at both end portions of the foam skin forming upper mold.

3. The molding apparatus of claim 1, wherein the foam skin forming upper mold is a vacuum forming mold that forms a foam skin by vacuum forming.

4. The molding apparatus of claim 1, further comprising:
a core forming upper mold that forms a cavity by combining with the lower mold and is configured to form a core by injecting a molten resin into the cavity.

5. The molding apparatus of claim 4, wherein the protrusion part of the slide mold is formed to face the lower mold toward an end of a core seated on the lower mold.

6. The molding apparatus of claim 4, further comprising:
a mold transfer device configured to move the core forming upper mold and the foam skin forming upper mold to alternately combine the core forming upper mold and the foam skin forming upper mold with the lower mold.

7. A molding method for manufacturing a crash pad of a vehicle, comprising:
vacuum-forming, by a foam skin forming upper mold, a foam skin including a skin and a skin foam layer under the skin;
simultaneously forming, by a slide mold of the foam skin forming upper mold, a foam skin protrusion part at an end portion of the foam skin;
combining the foam skin forming upper mold to which the foam skin is attached with a lower mold in which a core is formed;
pressuring, by a protrusion part of the slide mold, the foam skin protrusion part toward the core to allow the foam skin protrusion part to adhere closely to the end of the core by pushing an end portion of the foam skin toward the core when the slide mold of the foam skin forming upper mold operates; and
forming a foaming layer by injecting a bubble solution into a foaming cavity between the core of a core forming upper mold and the foam skin of the foam skin forming upper mold, to prevent a leakage upon forming of the foaming layer by sealing the core and the foam skin.

8. The molding method of claim 7, wherein the foam skin protrusion part includes a plurality of foam skin protrusions configured to be pressurized and adhered closely to both ends of the core.

9. The molding method of claim 7, wherein the skin is formed of a thermoplastic polyolefin material and the skin foam layer is formed of a polypropylene foam or a thermoplastic polyolefin foam.

10. The molding method of claim 7, wherein the skin is formed to a thickness of about 0.3 mm to about 1.0 mm and the skin foam layer is formed to a thickness of about 1.0 mm to about 3.0 mm.

11. The molding method of claim 7, wherein the skin foam layer has a compression rate about two times higher than that of the foaming layer.

12. The molding method of claim 9, wherein the polypropylene foam or the thermoplastic polyolefin foam used for the skin foam is formed by foaming a polypropylene or thermoplastic polyolefin material at a magnitude of about 10× to about 25×.

13. An injection product for a crash pad of a vehicle, comprising:
a core that is injection-molded;
a foam skin including a skin and a skin foam layer stacked inside the skin; and
a foaming layer formed by injecting a bubble solution into a cavity between the core and the foam skin, wherein the foam skin includes a foam skin protrusion part that protrudes toward the core, and is configured to allow the foam skin protrusion part to be pressurized and adhered closely to an end of the core.

14. The injection product of claim 13, wherein the foam skin protrusion part includes a plurality of foam skin protrusions configured to be pressurized and adhered closely to both ends of the core.

15. The injection product of claim 13, wherein the skin is formed of a thermoplastic polyolefin material and the skin foam layer is formed of a polypropylene foam or a thermoplastic polyolefin foam.

16. The injection product of claim 13, wherein the skin is formed to a thickness of about 0.3 mm to about 1.0 mm and the skin foam layer is formed to a thickness of about 1.0 mm to about 3.0 mm.

17. The injection product of claim 13, wherein the skin foam layer has a compression rate about two times higher than that of the foaming layer.

18. The injection product of claim 16, wherein the polypropylene foam or the thermoplastic polyolefin foam used for the skin foam is formed by foaming a polypropylene or thermoplastic polyolefin material at a magnitude of about 10× to about 25×.
